(19) United States
(12) Patent Application Publication
(10) Pub. No.: US 2012/0215804 A1
(43) Pub. Date: Aug. 23, 2012

(54) DATA-PROGRAMMING ENVIRONMENT

(75) Inventors: Erik Christensen, Shoreline, WA (US); Steve Millet, Edmonds, WA (US); Jason Falk, Seattle, WA (US); Giovanni Della-Libera, Seattle, WA (US)

(73) Assignee: MICROSOFT CORPORATION, Redmond, WA (US)

(21) Appl. No.: 13/162,771

(22) Filed: Jun. 17, 2011

Related U.S. Application Data
(60) Provisional application No. 61/444,174, filed on Feb. 18, 2011.

(51) Int. Cl. G06F 17/30; G06F 3/048

(52) U.S. Cl. 707/769; 715/764; 707/E17.014

(57) ABSTRACT

A data-programming environment is disclosed that facilitates data manipulation. Visual representations are presented of available operations with respect to one or more data sources. A preview of data is displayed capturing the state of data with respect to manipulations. Further, a visual representation of a series of selected operations is maintained to capture successive refinements and aid subsequent interaction.

### CROSS-REFERENCE TO RELATED APPLICATIONS

This application claims the benefit of U.S. Provisional Application No. 61/444,174, filed Feb. 18, 2011, and entitled “KNOWLEDGE-SCALABLE FRICTION-FREE DATA TRANSFORMATION,” and is incorporated in its entirety herein by reference.

### BACKGROUND

Data manipulation is one particular form of data processing. As the name suggests, data manipulation pertains to manipulating, or changing, data, for example to facilitate extraction of valuable information from less valuable data. Typical data manipulation operations include inserting, updating, deleting, sorting, and merging, among others.

Information workers, as well as the general public, are often first exposed to data manipulation with respect to spreadsheets. A spreadsheet is a computer application that enables easy analysis and manipulation of data utilizing tables and formulas. More specifically, data is stored in cells residing at intersections of columns and rows of a table, and relationships between cells can be defined by formulas. Data can be manipulated, to determine the impact of the modification on other data, for example. Such manipulation can correspond to changing column names, splitting data into multiple fields, stripping out undesirable characters, or combining data across multiple columns into a single column.

More advanced users such as application developers utilize a data manipulation language (DML) to specify data manipulation programmatically. The most popular DML is SQL (Structured Query Language), which is employed to retrieve and manipulate relational data. For example, data in a relational database can be manipulated by an application or directly by a developer utilizing SQL DML commands such as “INSERT,” “UPDATE,” and “DELETE,” among others.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to a data-programming environment that facilitates data manipulation. More specifically, visual representations of data manipulation operations can be afforded for selection and employment with respect to one or more data sources. Additionally, such operations can be specified and/or modified programmatically by more advanced/knowledgeable users. A data preview can also be displayed showing results of one or more data manipulation operations. Further, a task stream can employed to visually represent, as well as enable interaction with, a series of operations successively refining data over time.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of system that facilitates data manipulation.

FIG. 2 is a block diagram of a representative user-interface component.

FIG. 3 is a screenshot of an exemplary user interface.

FIG. 4 is a screenshot of an exemplary formula view.

FIG. 5 is a flow chart diagram of a method of facilitating data manipulation utilizing a preview.

FIG. 6 is a flow chart diagram of a method of facilitating data manipulation utilizing a task stream.

FIG. 7 is flow chart diagram of facilitating data manipulation by way of context-based operation presentation.

FIG. 8 is a schematic block diagram illustrating a suitable operating environment for aspects of the subject disclosure.

### DETAILED DESCRIPTION

Details below are generally directed toward a data-programming environment that facilitates data manipulation. Manipulating data into a desirable form is a difficult problem for users. Conventionally achievable data manipulation involves a laborious process demanding a substantial amount of learned knowledge. A friction-free and simple experience is provided by the data-programming environment disclosed herein that also scales in power with user knowledge.

More specifically, operations that perform data manipulation can be visually represented and selectable with a minimum number of gestures. Such operations can also be specified and/or modified programmatically with respect to a data manipulation language by more advanced/knowledgeable users. A preview of data can also be displayed showing the effects of one or more data manipulation operations. Further, a series of operations can be visually represented as a task stream that illustrates successive data refinement over time and as enables interaction at various times.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

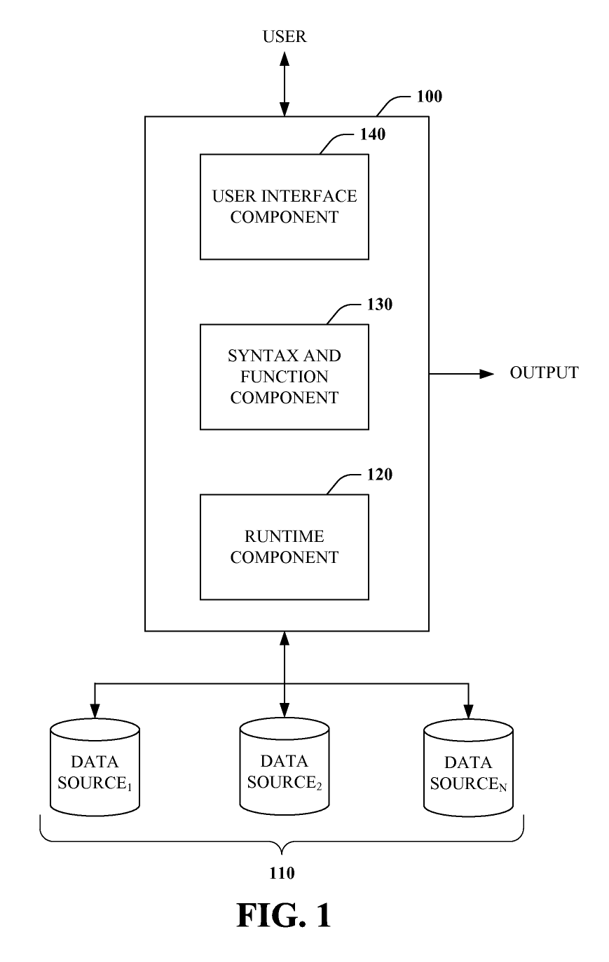

Referring initially to FIG. 1, illustrated is a system 100 that facilitates data manipulation, among other things. A prerequisite to data manipulation (a.k.a. data transformation or data shaping) is data itself. Accordingly, the system 100 is configured to interact with a plurality of data sources 110 (DATA SOURCE₁-DATA SOURCE_{N}, where “N” is a positive integer). Furthermore, the data sources 110 can be heterogeneous data sources that differ in various manners (e.g., data representations (e.g., text, tables, XML (Extensible Markup Language) . . . ), data retrieval (e.g., query processor, get mechanism . . . ), transformation capabilities, performance characteristics . . . ). For example, one data source can correspond to a relational database and another data source can correspond to a data feed or spreadsheet.

Runtime component 120 is configured to support execution of computer programs written in a computer programming language with respect to the data sources 110. By way of example and not limitation, the runtime component 120 can support execution with respect to an expression, or formula, specified in a functional programming language. In accordance with one embodiment, the runtime component 120 can provide homogeneous support for a simple set of operations across common data types. In other words, a computer program can be specified with a set of common operations regardless of specifics regarding particular data sources 110, and the runtime component 120 can perform requisite translations.

Furthermore, the runtime component 120 can be optimized in a number of ways. For instance, the runtime component 120 can be configured to enable streaming-based computation using delayed execution for expeditious preview generation. In other words, the runtime component 120 can execute a program, or portion thereof, lazily, or on-demand. Additionally, query and/or manipulation operations can be pushed to data sources 110 for execution, where able and efficient, to exploit data source optimizations. Furthermore, the runtime component 120 can be configured to analyze and optimize joins across disparate sources, for example by ensuring a filter is executed prior to a join.

Syntax and function library component 130 is configured to extend the functionality afforded by the runtime component 120. In particular, syntax can be supported for operation specification that minimizes concepts and maximizes expressivity of common data types and homogeneous and heterogeneous collections. Further, a small number of control flow operations can be supported to enable successive refinement of data. In addition, a set of application programming interfaces (APIs) is provided to enable interaction that scales from easy to use for an information worker to complete expressiveness for an advance user such as a developer.

The user interface component 140 provides a data-programming environment for data manipulation with respect to one or more data sources 110. Further, the user interface component 140 is configured generally to afford a friction-free and simple, or in other words smooth (e.g., easy to use, free from difficulties), user experience. The user interface component 140 can enable such interaction, exploiting functionality provided by the syntax and function library component 130 as well as the runtime component 120, to perform operations with respect to data from the data sources 110. Furthermore, upon instruction by a user, data manipulated in accordance with a series of one or more specified operations can be acquired from one or more data sources 110 and output or exported to another location or source. In other words, the user interface component 140 is employed to specify a data manipulation program that is executed and the results of which are output. By way of example and not limitation, an information worker can employ the system 100 to facilitate acquisition and manipulation of data which can then be imported into, or exported to, an application of choice such as a spreadsheet application instead of performing such actions directly in the application of choice.

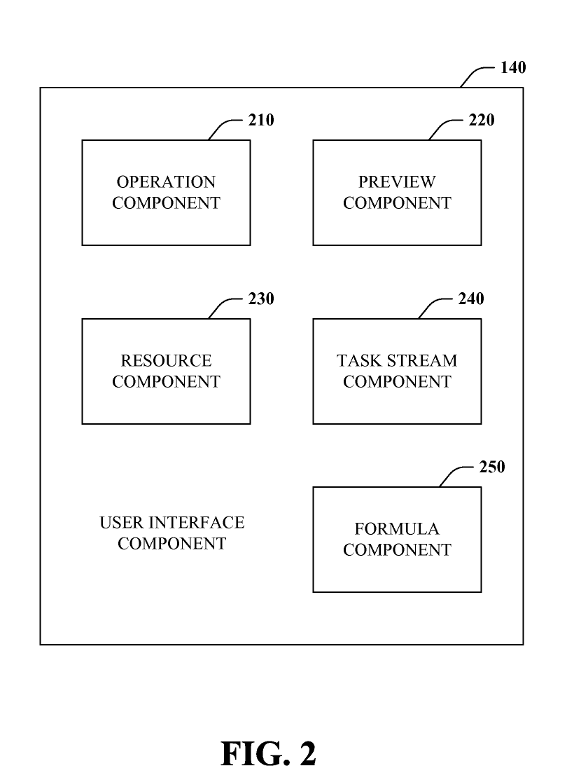

Turning attention to FIG. 2, a representative user-interface component 140 is presented in detail. Operation component 210 is configured to provide easy access to, and selection of, data manipulation operations, as provided by a programing language supported by the subject system. Although not limited thereto, visual representations of operations can be presented (e.g., user interface metaphors) for selection in accordance with one embodiment. In other words, the operation component 210 can map user-interface elements to operations of a data-manipulation programming language, thereby providing a match between the language, runtime, libraries, and user interface.

Further, the operation component 210 can be configured to present such operations in a toolbar, ribbon interface, or the like. A toolbar is an element of a graphical user interface used to initiate particular actions upon selection (e.g., click, double click . . . ). Here, a toolbar can be populated with visual representations of manipulation operations to initiate, potentially grouped by functionality. A ribbon interface, or simply a ribbon, corresponds to a user interface comprising a set of toolbars organized with respect to tabs. In this instance, multiple toolbars can be employed to facilitate access to data manipulation operations.

The operation component 210 can also control presentation of operations as a function of context, for example, including data type, previously selected operations, and/or cursor position, among other things. By way of example and not limitation, the operations presented by a ribbon can change dynamically as a function of acquired, determined, or inferred context information.

Preview component 220 is configured to display a preview of data subject to initial or subsequent manipulation. Further, the preview can be constant in terms of being continuously available with respect to manipulation operations. As well, the preview can be of a constant size or predetermined maximum size. As is the nature of a preview, a subset of data can be exposed, such as thirty rows of a table, for example. Accordingly, upon application of an operation, the preview can change to reflect execution of the operation but remain constant at thirty rows (unless the result set is less than thirty rows). In addition, the preview component 220 enables scalability or an ability to deal with small data sets (e.g., one-hundred-row table) as well as very large data sets (e.g., one-hundred-million-row table).

Note that the format of the preview can be dictated by an adopted common (a.k.a., standard or neutral) format across heterogeneous data sources. Stated differently, data can be normalized to a common representation. In accordance with one embodiment, the common format can be a table such that data is presented at the intersection of a number of columns and rows regardless of a data source representation (e.g., common separated file). In this manner, a user can interpret data in a familiar form, namely spreadsheet table form.

The size of a preview can be predetermined as a function of available and designated screen space. In other words, the preview size can differ for different devices (e.g., mobile phone vs. tablet computer vs. desktop computer) based on their screen size as well as a particular graphical user interface layout. However, the preview size can change dynamically if available or designated screen space changes.

Further and in accordance with one embodiment, the operations can be pushed to data sources for execution if the data sources have such capability (e.g., execution engine, query processor . . . ). In this manner, optimizations or efficiencies, associated with data source execution can be exploited to facilitate at least expeditious display of a preview as opposed to executing the operations locally with the runtime component 120, for example. Further yet, the entire result set need not be returned and subsequently filtered for a preview. Rather, the filtering can be performed by the data source, such that the amount of data returned corresponds to that utilized to populate a preview.

By way of example and not limitation, suppose the domain is a million-row database. The preview component 220 alone or in combination with other system components can efficiently request and display the first thirty rows. After a data manipulation task is specified, a new preview can be displayed to reflect changes. However, the preview need not be determined locally, instead at least a portion of the operation can be pushed back to the data source (e.g., as much as data source will allow) to enable maximum efficiency by leveraging data source indices and other optimization techniques. In other words, if a manipulation operation specifies selection of every fifth row, execution of this operation can be pushed to a back-end data source (e.g., relational database) that can return thirty rows. The consequence of not executing the operation in this manner results in a need to acquire a substantial amount of data and subsequently filter the results to fill thirty rows, which is a more complicated process.

Conventional technologies associated with data manipulation acquire all the data and perform operations locally. In addition to the delay associated with acquiring the data, it is not always possible to acquire all the data due to the size thereof and local system constraints (e.g., amount of random access memory). An alternative technique conventionally employed is to work with respect to a subset of data. This technique suffers from a different problem since an operation or operations may require the entire data set (e.g., aggregate values on every fifth row).

The performance benefits of pushing execution to a data source enables previews to be generated and displayed promptly. In some situations, however, the data source may not be capable of executing a manipulation operation and returning results for a preview. Consider a flat file, for instance. In this situation, the flat file can be moved to an alternate data source that enables execution such as a relational database, but there is an upfront cost in terms of at least time of moving the data. Nevertheless, the benefits of expeditious previews may outweigh the cost. For example, the data can be moved the night before data manipulation is to be performed.

Resource component 230 is configured to facilitate identification and selection of one or more data sources. In accordance with one embodiment, the resource component 230 can present a visual representation of a data source over which data manipulation can be performed. Where multiple data sources, including heterogeneous data sources are involved, the resource component 230 can identify each of the data sources. Selection of one of the data source by way of a gesture can make the selected data source active. Accordingly, a preview and available operations for the selected data source can be displayed.

Task stream component 240 is configured to present a visual representation of a series of manipulation operations performed with respect to data, or in other words a task stream. Each operation represents an incremental manipulation or, stated differently, a successive refinement of data. Accordingly, the task stream grows as a user selects additional operations to execute over a data. Furthermore, the task stream component 240 can operate in combination with the preview component 220 such that for each operation, or task, executed a preview of the data is displayed. Accordingly, upon selecting a manipulation operation to perform, the manipulation operation can be presented in the task stream and a preview of data after execution of the operation can be displayed.

Furthermore, the task stream component 240 can interact with the preview component 220 to inject interactive controls within a displayed preview to allow users to manipulate data in a “what you see is what you get” manner. By way of example and not limitation, a user can select a way to order data in a column from a drop down menu, reorder columns by dragging and dropping column icons representing column names, check a boxes above columns to identify columns to merge, check boxes above columns to remove columns, or fill in text box to rename a column, among other things. In other words, the interactive controls facilitate specification of specifics regarding an operation in the task stream.

Moreover, each operation in the task stream is selectable by way of a gesture, and selection results in a preview being displayed that captures execution of the particular manipulation operation as well as preceding operations in time. Furthermore, any changes made to the data can be automatically carried forward with respect to dependent manipulation operations. Tasks can also be moved in the stream with respect to other tasks, collapsed into a set of other tasks, or refactored, among other things.

By way of example, consider a scenario where the data manipulation does not work because there was an associated data source changed a column name. A user can employ the task stream to navigate to a point that deals with the column or the system can identify the error with an icon with respect to the problem task. Upon selection of the problem task, the user can rename the column to what is expected by subsequent manipulation operations. The change is then carried forward and the problem is fixed.

The task stream component 240 in combination with the operation component 210, the preview component 220, and the resource component 230 makes data manipulation easy for information workers, as well as the general public, to perform arbitrarily complex data manipulations. In other words, there is not a large amount of learned knowledge required to manipulate data. Data manipulation operations are represented visually as user interface metaphors (e.g., graphic illustrating a column being split into two columns for a split operation), which can be selected for execution, which can then result in insertion of the operation in a task stream and preview of the data with the applied operation. As users gain knowledge through interaction with the system and/or other means, they may wish to specify data manipulations more directly. Formula component 250 provides that mechanism.

Formula component 250 provides a visual representation of a programmatic expression, or formula, specified in a supported underlying data manipulation language. As data manipulation operations are specified, utilizing the graphical representations, the formula component 250 can display the corresponding programmatic expression or formula (e.g., specified in accordance with a program language grammar) that is produced automatically behind the scenes. This provides a user an opportunity to learn more about the underlying data manipulation language. Further, the formula component 250 can accept data manipulation operations or modification of the displayed expression directly. Stated differently, operations can be specified and/or modified programmatically with respect to a data manipulation language. Results can be produced as if the changes were specified utilizing graphical user interface mechanisms. Consequently, a more advanced user, such as a developer, can access the full expressiveness of the underlying data manipulation language through direct specification. To further aid direct specification, automatic completion functionality can be employed by the formula component 250 to predict and suggest characters, words, phrases, keywords, symbols, etc. as a function of a currently specified expression and a grammar (e.g., syntax) associated data manipulation language employed.

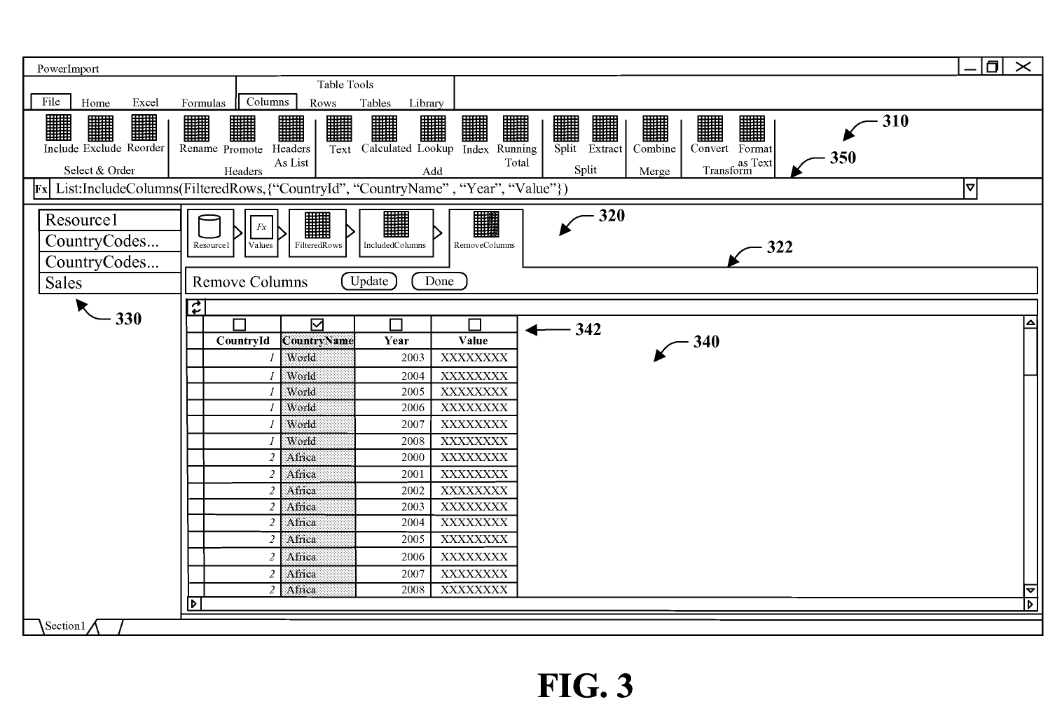

FIG. 3 is a screenshot illustrating exemplary embodiments of various aspects produced by the user interface component 140. The subject screenshot is provided to facilitate clarity and understanding with respect to aspects of the disclosure. Accordingly, the claimed subject matter is not intended to be limited thereto, as there are various ways to present and interact with elements of graphical user interface to produce substantially the same results.

As shown, ribbon 310 is provided that is able to present a number of toolbars. Here, the “Table Tools” toolbar has been selected. Further, there are a series of tabs representing, among other things, where actions can be performed (e.g., on columns, rows, tables . . . ). Here, the “Columns” tab has been selected and data manipulation operations are segmented by functionality (e.g., Select & Order, Headers, Add, Split, Merge, transform).

Task stream 320 is also depicted providing a record of data manipulation operations. As shown, the task stream includes number of boxes with graphics indicative of a resource and particular operations. Arrows are positioned between the boxes pointing to the right to indicate operations over time or successive refinement from left to right. Further, although not shown, it is to be appreciated that upon selection of a task additional graphical user interface support can be provided to facilitate specification of a particular task including, for example, text boxes, drop down boxes, and buttons, among other things.

To the left of the task stream 320 there are a number of tabs 330 that specify a plurality of data sources over which data manipulation can be performed. Here, the first tab “Resource1” is active. Selection of another tab would bring the selected data source to the forefront.

Preview 340 is a window pane that displays a subset of data that satisfies the manipulation operations over a data source as specified in the in the task stream 320 as well as syntactically in the formula bar 350. As shown, the preview displays data in a common table representation. Further, it is to be appreciated that the preview 340 can be modified substantially in real-time in response to additional tasks such as filtering operations performed thereon or merging data from heterogeneous data sources.

The task stream 320 can also interact with the preview component 340 to inject interactive controls. With respect to a task that removes columns, as shown here, boxes 342 are injected in the preview 340 over each column that can be selected by checking the box to indicate that the column is to be removed. Here, one column is selected for removal as indicated by gray shading. The task stream 320 also includes a portion 322 associated with a task including buttons to update the data based on interaction with the preview controls and to indicate manipulation with respect to that particular task and the preview controls is complete or done.

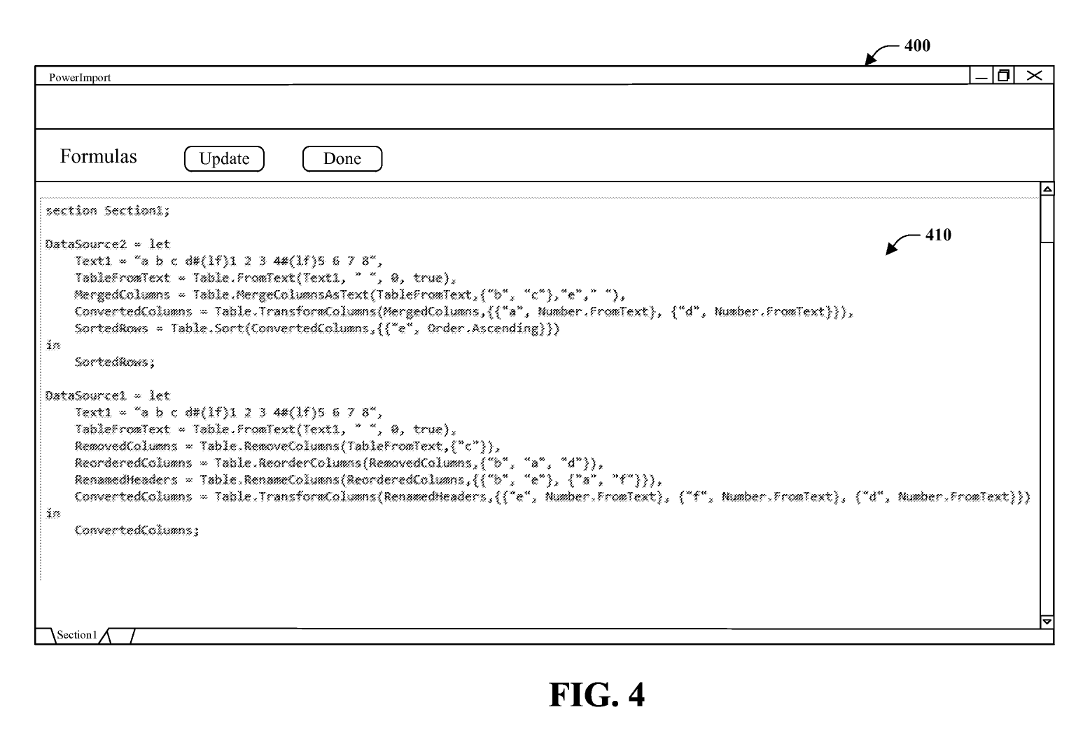

In sum, a program is built up (e.g., query, query builder . . . ) of various tasks in response to simple user interface gestures (e.g., pointing, clicking . . . ). Furthermore, such interface gestures are tied to the formula bar 350, which is also directly modifiable by advanced users. Further yet, all formulas associated with a task stream, or in other words, an entire program, can be displayed, for instance in a separate formula view window or windowpane. By way of example, FIG. 4 illustrates an exemplary formula view screenshot 400 depicting an entire program 410. In this manner, advanced users can directly edit the entire program that resources and the task stream manage.

There is a spectrum of programming environments. On one side, there is a traditional programming environment, in which a program is compiled, run, and debugged. On the other side is a macro recorder, in which actions are recorded and run again later. The traditional programming environment is very detailed and the programmer has complete control. However, the programmer does not immediately know what the actual effects of actions will be, because that is not known until the program is run. Accordingly, the friction, or difficulty, associated with taking that approach many times is high. At the other end of the spectrum, the macro recorder is very easy, but if any mistakes are made, it will be almost impossible to edit that macro recording. Additionally, if a programmer had to run through actions thirty times, for example, to get a perfect recording that is very arduous and painful. Furthermore, the traditional programming environment is directed to an advanced user such as a developer with substantial knowledge while the macro recorder is directed to an information worker with little required knowledge.

The subject programming-environment generated by the user interface component 140 differs from the aforementioned programming environments and may be situated somewhere in the middle of the spectrum. First, the subject programming-environment targets an information worker, or, in other words, little learned knowledge is necessary. However, the subject programming-environment also supports users that are more advanced. Further, the programming environment is constantly running (or at least appears that way (e.g., lazy/on-demand execution)), so a user can continually observe the effects of executed operations. As well, the task stream can be continuously shaped or manipulated. Here, as soon as the middle of a task stream is changed, the user/programmer can go to the end of the task stream and ensure the value is correct. In a traditional programming environment, if a line of code is changed in the middle, it might take a programmer a few hours debugging before the programmer figures out that the code was fixed in the middle and the result is correct. With respect to a macro recorder, you have to continually record a new macro and debug.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the user interface component 140 can utilize such mechanisms to determine or infer data manipulation operations to present as a function of context.

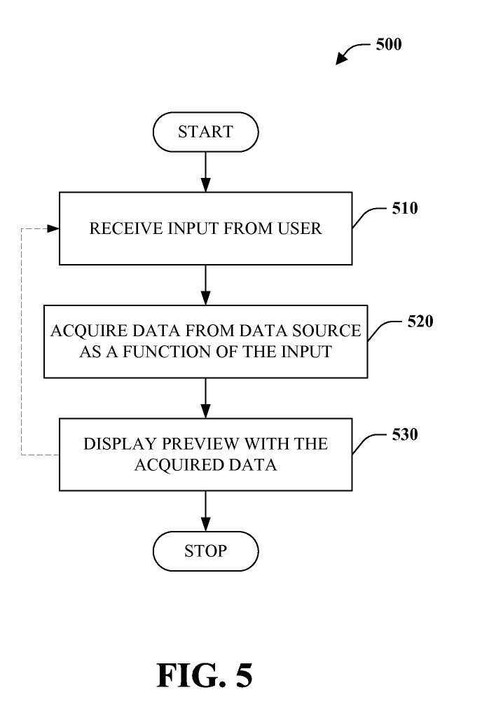

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method 500 of facilitating data manipulation utilizing a preview is illustrated. At reference numeral 510, input is received from a user regarding data manipulation. For example, such input can correspond to a data manipulation operation. At reference numeral 520, data is acquired from a data source as function of the input. For example, a data manipulation operation can be sent to a data source for processing where the data source has the capability of executing the operation. Furthermore, the data manipulation operation can be specified with a filter to return a subset of data. At numeral 530, a preview is displayed with the acquired data (e.g., subset of data satisfying manipulation constraints). Subsequently, the method 500 can terminate. Optionally, the method can continue at 510 where additional input is acquired from a user. In essence, the method 500 can run continuously to accept user input and display a preview.

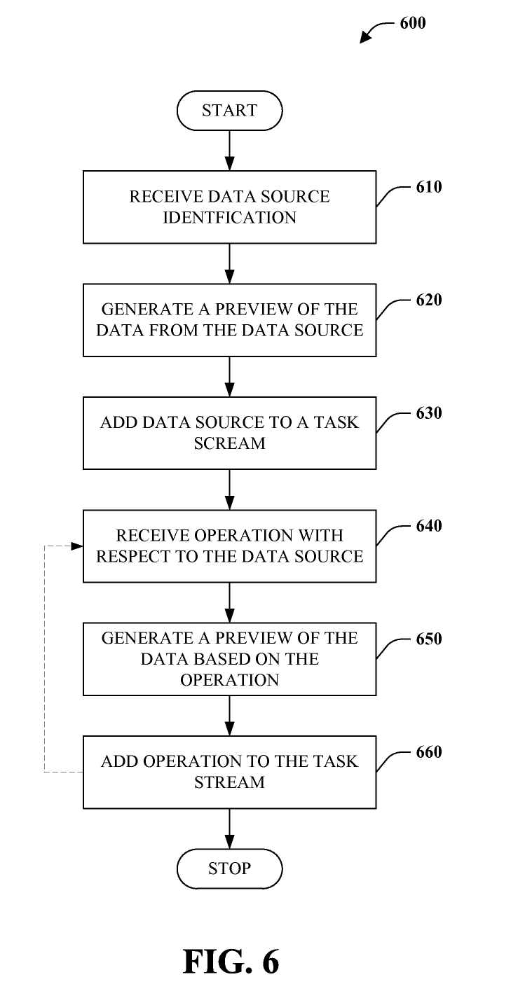

FIG. 6 depicts a method 600 of facilitating data manipulation utilizing a task stream. At reference numeral 610, identification of a data source is received, for example from a user by way of a user interface. At reference 620, a preview is generated and displayed for the data source. At numeral 630, the data source is added to a task stream identifying particular user actions, here identification of the data source. At reference numeral 640, a data manipulation operation is received with respect to the identified data source by way of selection of a graphical representation of an operation or specification of the operation with respect to a programmatic expression, or formula, for example. At numeral 650, a preview is generated and displayed based on the operation. In one embodiment, preview generation can correspond to pushing the operation to the data source for execution with a filter and accepting the results. At numeral 660, the operation is added to the task stream. Subsequently, the method 600 can terminate or alternatively loop back to 640 to continue to receive addition data-manipulation operations.

Once constructed the task stream can be utilized to navigate to particular operations to make changes. For example, if the task stream has been running for some time and an error occurs, for instance because a date previously represented with slashes (e.g., 1/1/2011) was changed and is now represented with dashes (e.g., 1-1-2011), a user can navigate to a particular portion of the task stream and make a change that will be reflected with respect to subsequent operations in the task stream. Furthermore, operations represented as tasks can also be moved in the stream with respect to other tasks, collapsed into a set of other tasks (e.g., more than one operation in a task), or refactored, among other things.

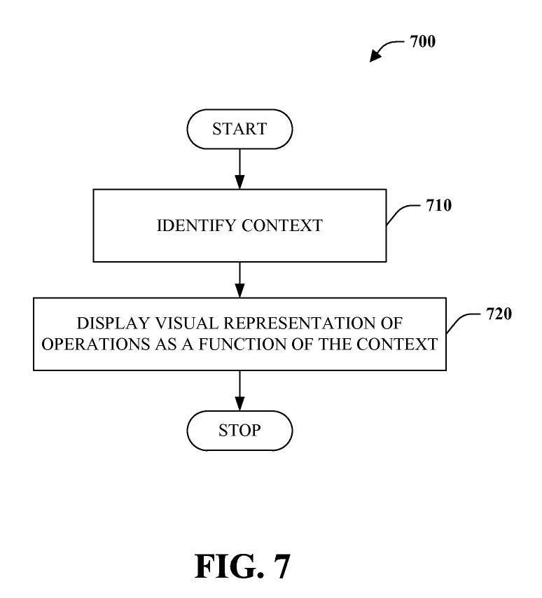

FIG. 7 is a flow chart diagram of a method 700 of facilitating data manipulation. At reference numeral 710, context information can be identified. Such information can correspond to a data source, data, data manipulation operations, user history (e.g., previous data manipulation), and/or popular operations among other things. At numeral 720, a visual representation of data manipulation operations is displayed as a function of the context information identified. For example, where operations are represented visually in a ribbon interface, those operations that are determined to be relevant based on the context can be displayed for user selection over other operations that are not as relevant.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

In order to provide a context for the claimed subject matter, FIG. 7 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

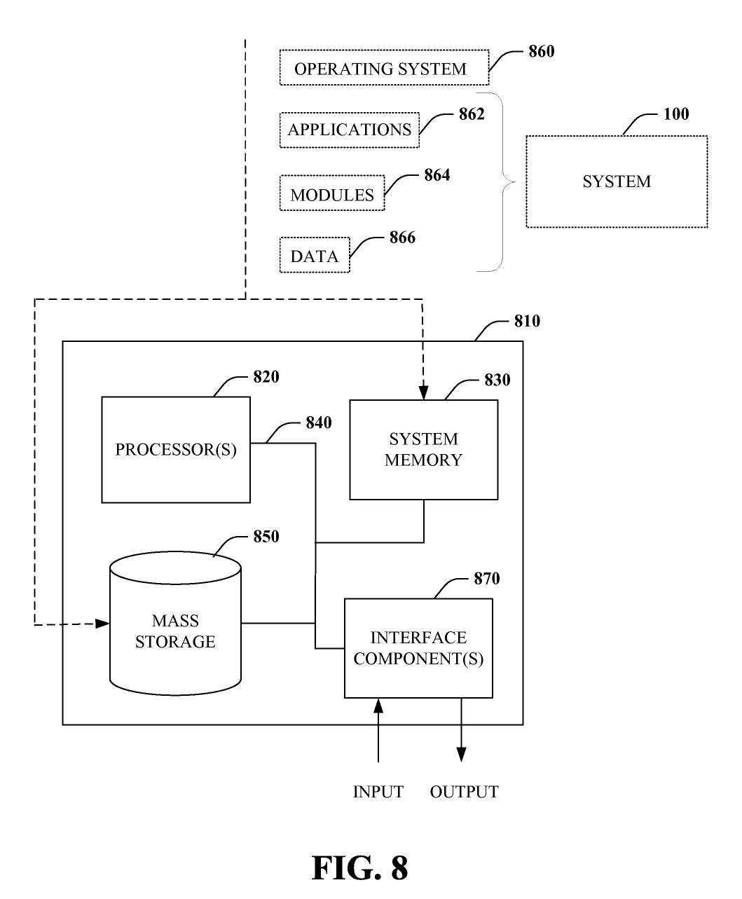

With reference to FIG. 8, illustrated is an example general-purpose computer 810 or computing device (e.g., desktop, laptop, server, hand-held, programmable consumer or industrial electronics, set-top box, game system . . . ). The computer 810 includes one or more processor(s) 820, memory 830, system bus 840, mass storage 850, and one or more interface components 870. The system bus 840 communicatively couples at least the above system components. However, it is to be appreciated that in its simplest form the computer 810 can include one or more processors 820 coupled to memory 830 that execute various computer executable actions, instructions, and or components stored in memory 830.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 810.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the system 100 that facilitates data manipulation, or portions thereof, can be, or form part, of an application 862, and include one or more modules 864 and data 866 stored in memory and/or mass storage 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810 through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating data manipulation, comprising:
employing at least one processor configured to execute computer-executable instructions stored in memory to perform the following acts:
displaying a subset of data acquired from at least one external data source in a portion of a graphical user interface in response to a query issued to the external source for the subset of data that satisfies a specified data manipulation operation.

2. The method of claim 1 further comprises presenting a visual representation of operations supported by a data manipulation language.

3. The method of claim 2, presenting a subset of the operations as a function of context.

4. The method of claim 2, presenting the operations in a ribbon.

5. The method of claim 1 further comprises presenting a visual representation of the specified data manipulation operation.

6. The method of claim 5, presenting a visual representation of a series of specified data manipulation operations in order in which the operations were specified.

7. The method of claim 6 further comprises displaying the subset of data associated with a data manipulation operation selected from the series of specified data manipulation operations.

8. The method of claim 1 further comprises displaying programming language syntax for the specified data manipulation operation.

9. A system that facilitates data manipulation, comprising:
a processor coupled to a memory, the processor configured to execute the following computer-executable components stored in the memory:
a first component configured to present a visual representation of series of operations performed with respect to a data source; and
a second component configured to display a preview of data that results from execution of one or more operations in the series of operations.

10. The system of claim 9, the one or more operations are performed across heterogeneous data sources.

11. The system of claim 10, the preview is displayed in a data-source independent format.

12. The system of claim 9, the one or more operations are executed by an external data source.

13. The system of claim 9, the second component displays the preview upon selection of an operation from the series of operations.

14. The system of claim 9 further comprises a third component configured to present visual representations of one or more available operations.

15. The system of claim 9 further comprises a third component configured to present a visual representation of an expression that specifies the series of operations.

16. The system of claim 9, the second component is configured to provide one or more interactive control elements with the preview of data to specify specifics regarding one of the series of operations presented by the first component.

17. A computer-readable storage medium having instructions stored thereon that enables at least one processor to perform the following acts:
presenting a visual representation of operations that when executed manipulate data from arbitrary data sources;
presenting a visual representation of one or more selected operations; and
displaying a preview of data from the arbitrary data sources for the one or more selected operations.

18. The computer-readable storage medium of claim 17, presenting a visual representation of the one or more selected operations as a programmatic expression.

19. The computer-readable storage medium of claim 17, presenting a visual representation of the operations as a function of context.

20. The computer-readable storage medium of claim 17 further comprises querying the arbitrary data sources for a subset of data for the preview.
